(19) United States
(12) Patent Application Publication
(10) Pub. No.: US 2010/0302457 A1
(43) Pub. Date: Dec. 2, 2010

(54) LIGHTING DEVICE, DISPLAY DEVICE AND TELEVISION RECEIVER

(75) Inventors: Shuki Yamamoto, Osaka-shi (JP); Tamotsu Satoh, Osaka-shi (JP)

Correspondence Address: SHARP KABUSHIKI KAISHA;C/O KEATING & BENNETT, LLP, 1800 Alexander Bell Drive, SUITE 200, Reston, VA, 20191, US

(73) Assignee: SHARP KABUSHIKI KAISHA, Osaka-shi, Osaka (JP)

(21) Appl. No.: 12/864,556

(22) PCT Filed: Jan. 21, 2009
(86) PCT No.: PCT/JP2009/050876

§ 371 Date: Jul. 26, 2010

(30) Foreign Application Priority Data
Feb. 19, 2008 (JP) 2008-037537

(51) Int. Cl. H04N 5/44; F21S 4/00; G02F 1/13357; G02F 1/1335

(52) U.S. Cl. 348/725; 362/249.01; 362/97.1; 349/61; 348/E05.096

(57) ABSTRACT

A lighting device 12 of the present invention includes a plurality of light sources 17 and a chassis 14 that accommodates the light sources 17. The chassis 14 is constructed of a plate member including a flat bottom plate 14a and outer rims 21 having a folding configuration 31 formed at the edges of the bottom plate 14a. At the outer rim 21, a core member 40 extending in a longitudinal direction of the outer rim is provided in a folded part of the folding configuration 31. The outer rim 21 provided with the core member 40 improves strength of the outer rim 21 itself. This suppresses distortion of the chassis 14 and uniform brightness is provided.

### TECHNICAL FIELD

The present invention relates to a lighting device, a display device and a television receiver.

### BACKGROUND ART

A liquid crystal panel included in a liquid crystal display device such as a television does not emit light, and thus a backlight device is required as a separate lighting device. The backlight device is arranged behind the liquid crystal panel (i.e., on a side opposite from a display surface side). It includes a metal chassis having an opening on a liquid crystal panel side and a plurality of lamps (e.g., cold cathode tubes).

To make the liquid crystal display device thinner, each component of the backlight device has been made thinner. The reduction in thickness of the components decreases strength of the components and accordingly lowers durability or display quality of the liquid crystal display device.

The chassis is generally comprised of a flat bottom plate and an outer rim that extends upright from a periphery of the bottom plate. To make the chassis thinner, a height from the bottom plate to an upper end of the outer rim of the chassis is required to be small. The outer rim of the chassis has a function for maintaining strength of the whole chassis. Therefore, if the height of the outer rim is small, the strength of the outer rim itself is decreased and a force for suppressing distortion of the chassis may become insufficient. If a part of the chassis gets distorted, the gaps between each cold cathode tube accommodated in the chassis and the chassis become varied. This may vary the amount of light emission from each cold cathode tube and this may lower display quality of the liquid crystal display device. For example, Patent Document 1 discloses a configuration for improving the strength of the chassis.

[Patent Document] Japanese Unexamined Patent Publication No. 2005-317356

### Problem to be Solved by the Invention

The chassis disclosed in Patent Document 1 includes a chassis body including an elongated top panel, side plates each of which is bent from each of two side portions of the top panel in its width direction and a frame that is bent in a direction opposite to the bending direction of the side plates and is provided at a distal end of each side plate. The chassis further includes end plates each of which is attached to each of two ends of the top panel in its longitudinal direction and a reinforcing fitting that is provided on the chassis body at a side opposite to the bending direction of the side plate and holds and urges the frame at a substantially center of the chassis body so as to expand the frame. This prevents contraction of the side plates and the frame.

However, in the above structure, the reinforcing fitting is provided on the top panel of the chassis, and this hinders the thickness reduction of the chassis. The thickness reduction and ensuring of the strength of the chassis are conflicting requirements. Therefore, another reinforcing means has been required to be considered.

### DISCLOSURE OF THE PRESENT INVENTION

The present invention was made in view of the foregoing circumstances. An object of the present invention is to provide a lighting device having a uniform brightness distribution with using a chassis for suppressing its strength decrease due to thickness reduction. Another object of the present invention is to provide a display device including such a lighting device and a television receiver including such a display device.

### Means for Solving the Problem

To solve the above problem, a lighting device of the present invention includes a plurality of light sources and a chassis configured to accommodate the light sources. The chassis includes a flat bottom plate and an outer rim that is formed at an edge of the bottom plate and has a folding configuration. A core member is provided in a folded part of the folding configuration at the outer rim so as to extend in a longitudinal direction of the outer rim.

Thus, the folding configuration is provided at the outer rim that is formed at the edge of the bottom plate of the chassis and the core member is provided in the folded part of the folding configuration (inside the folded part). This improves the strength of the outer rim itself and suppresses the distortion of the whole chassis.

The outer rim having the folding configuration that is provided at the edge of the bottom plate has a function for applying strength to the chassis of a plate shape that is required to suppress the distortion of the chassis. However, to make the chassis thinner, a height from the bottom plate to an upper end of the outer rim is required to be made smaller. In such a case, the strength of the outer rim itself is decreased compared to the conventional one. This decreases the strength of the whole chassis and the distortion may be caused in the chassis.

If the distortion is caused in the chassis, a distance between each light source accommodated in the chassis and the chassis is varied. If the chassis is formed of a metal for example, slight leakage is occurred from the light sources form the chassis and the leakage amount is inversely proportional to the distance between the light sources and the chassis. Therefore, if the distance between each light source and the chassis is different due to the distortion of the chassis, the leakage amount is varied with each light source. In a case in that a large distance between the light sources and the chassis can be ensured, even if the distance therebetween is changed due to the distortion of the chassis, the variation of the leakage amount in the light sources is small since the distance change amount with respect to the design distance is relatively small. Accordingly, this does not affect the variation of current flowing in the light sources. However, since the distance between the light sources and the chassis is small in the thin chassis, the distance change amount with respect to the design distance is relatively great. As a result, this increases the variation of current flowing in the light sources, and accordingly the brightness of each light source may be different.

However, according to the lighting device of the present invention, the core member is provided to the outer rim where the strength is applied by the folding configuration. This improves the strength of the whole chassis and the distortion is not cause in the thin chassis. Accordingly, since the distance between the light sources and the chassis is maintained to be the design distance, the leakage amount from each light source to the chassis is constant and this does not affect the variation of current flowing in the light sources, that is, the variation of brightness. As a result, especially in the thin lighting device, a uniform light brightness distribution is ensured.

Further, the core member is provided in the folded part of the outer rim, that is, in a space that is formed by the folding configuration (a space surrounded by the folded part). Therefore, a different space for arranging the core member is not necessary to be prepared and the reinforcement of the outer rim is enabled without hindering the thickness reduction of the lighting device.

### BRIEF DESCRIPTION OF THE DRAWINGS

FIG. 1 is an exploded perspective view illustrating a general construction of a television receiver according to a first embodiment of the present invention;

FIG. 2 is an exploded perspective view illustrating a general construction of a liquid crystal display device provided in the television receiver shown in FIG. 1;

FIG. 3 is a cross-sectional view of the liquid crystal display device in FIG. 2 along the short-side direction;

FIG. 4 is a cross-sectional view of the liquid crystal display device in FIG. 2 along the long-side direction;

FIG. 5 is an enlarged cross-sectional view of a main portion of the liquid crystal display device in FIG. 3;

FIG. 6 is an enlarged cross-sectional view of a main portion of the liquid crystal display device in FIG. 4

FIG. 7 is a perspective view illustrating a construction of a reinforcing plate attached to an outer rim of the chassis of the liquid crystal display device in FIG. 2;

FIG. 8 is a cross-sectional view illustrating one modified example of a long-side second folded portion provided at a long-side outer rim of the liquid crystal display device in FIG. 3;

FIG. 9 is a cross-sectional view illustrating an additional modified example of a long-side second folded portion;

FIG. 10 is a cross-sectional view illustrating one modified example of a short-side second folded portion provided at a short-side outer rim of the liquid crystal display device in FIG. 4;

FIG. 11 is a cross-sectional view illustrating another modified example of the short-side second folded portion;

FIG. 12 is a cross-sectional view illustrating a cross-sectional configuration along a short-side direction of the liquid crystal display device according to a second embodiment of the present invention;

FIG. 13 is a cross-sectional view illustrating a cross-sectional configuration along a long-side direction of the liquid crystal display device;

FIG. 14 is a cross-sectional view illustrating one modified example illustrating an attachment example of a reinforcing plate attached to the long-side outer rim of the liquid crystal display device in FIG. 12;

FIG. 15 is a cross-sectional view illustrating one modified example illustrating an attachment example of the reinforcing plate attached to the long-side outer rim;

FIG. 16 is a cross-sectional view illustrating another modified example illustrating an attachment example of the reinforcing plate attached to the long-side outer rim;

FIG. 17 is a cross-sectional view illustrating one modified example illustrating an attachment example of the reinforcing plate attached to the short-side outer rim of the liquid crystal display device in FIG. 13;

FIG. 18 is a cross-sectional view illustrating an additional modified example illustrating an attachment example of the reinforcing plate attached to the short-side outer rim;

FIG. 19 is a cross-sectional view illustrating a further additional modified example illustrating an attachment example of the reinforcing plate attached to the short-side outer rim;

FIG. 20 is a cross-sectional view illustrating one modified example of the short-side outer rim; and

FIG. 21 is a cross-sectional view illustrating one modified example illustrating a configuration in that a screw is inserted through components to fix them.

### BEST MODE FOR CARRYING OUT THE INVENTION

### First Embodiment

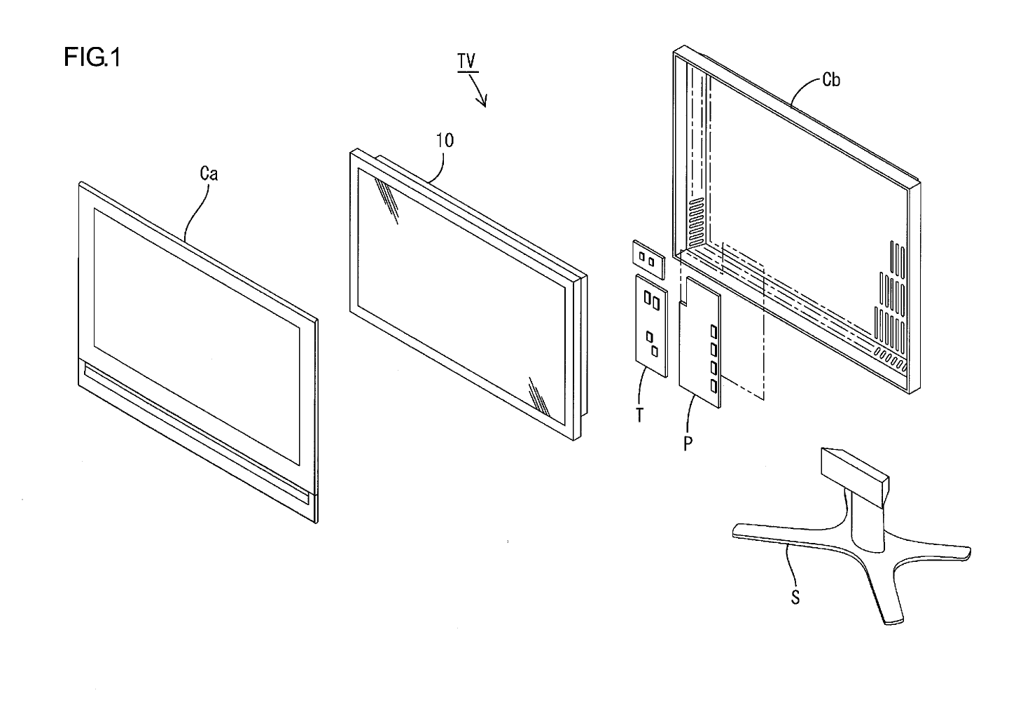

The first embodiment of the present invention will be explained with reference to FIGS. 1 to 6. In the first embodiment, a television receiver TV including a liquid crystal display device 10 will be explained.

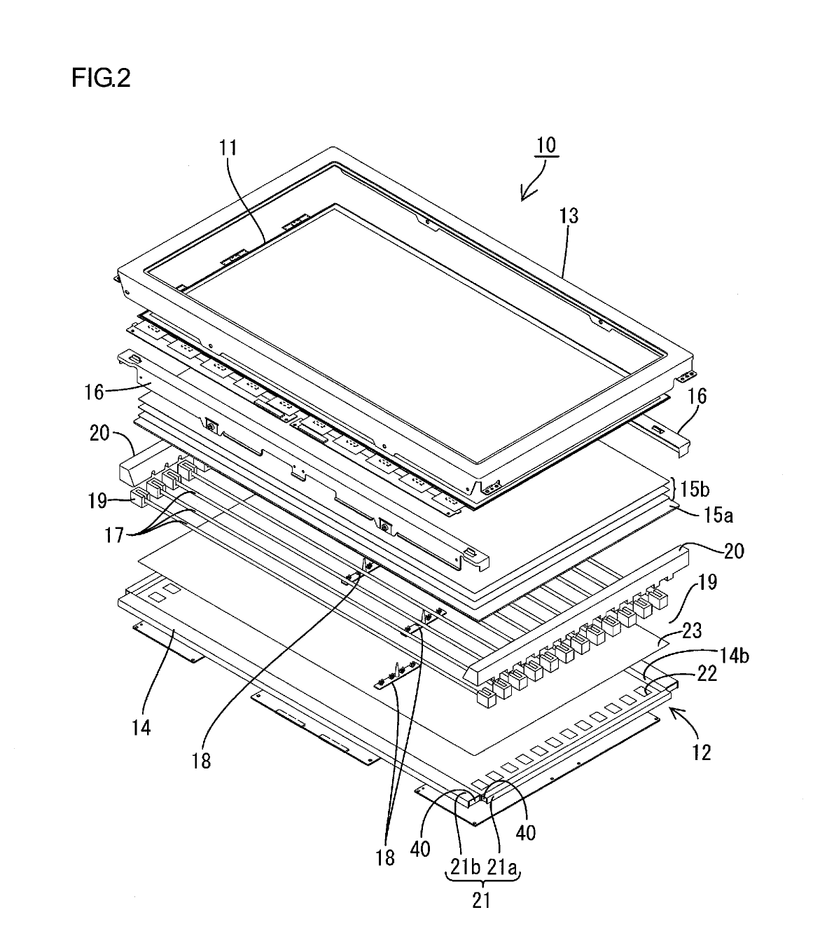

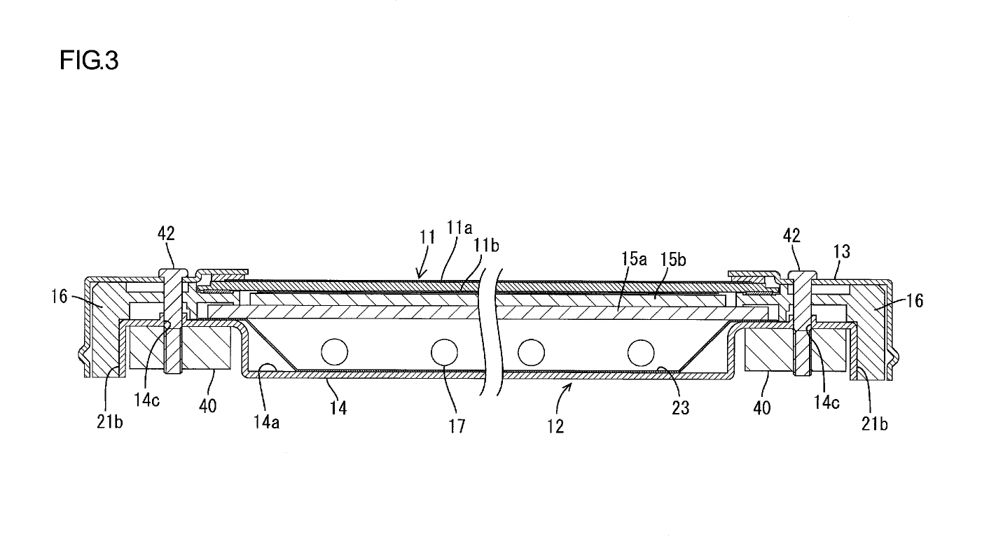

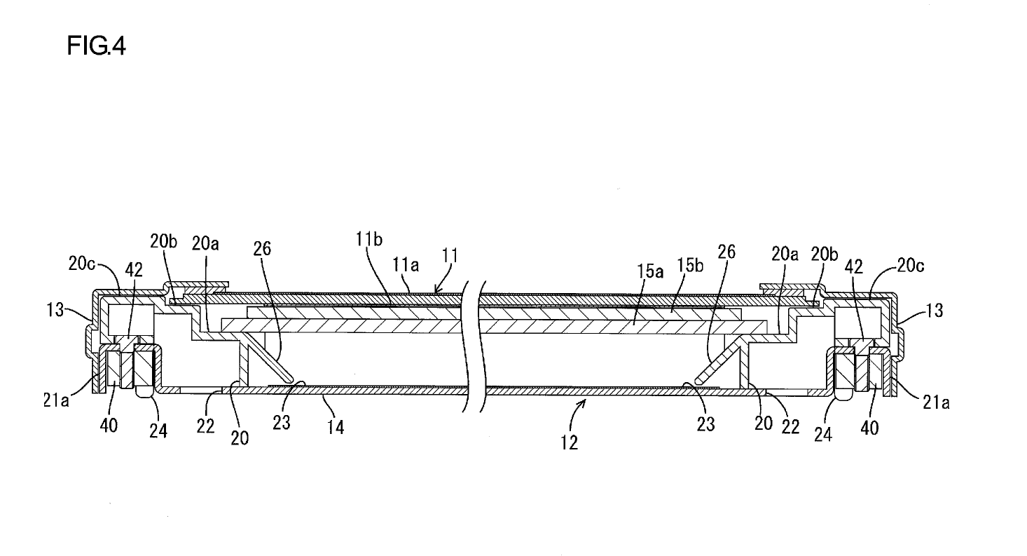

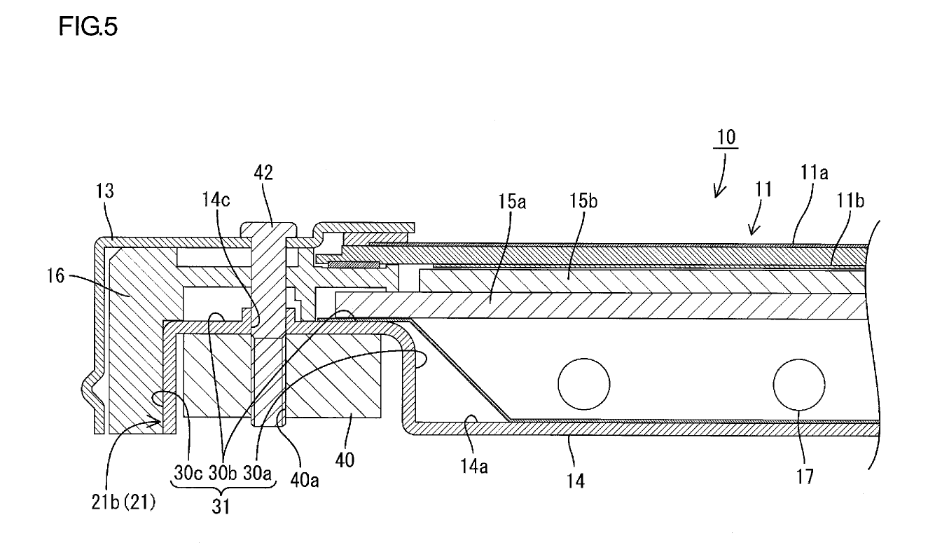

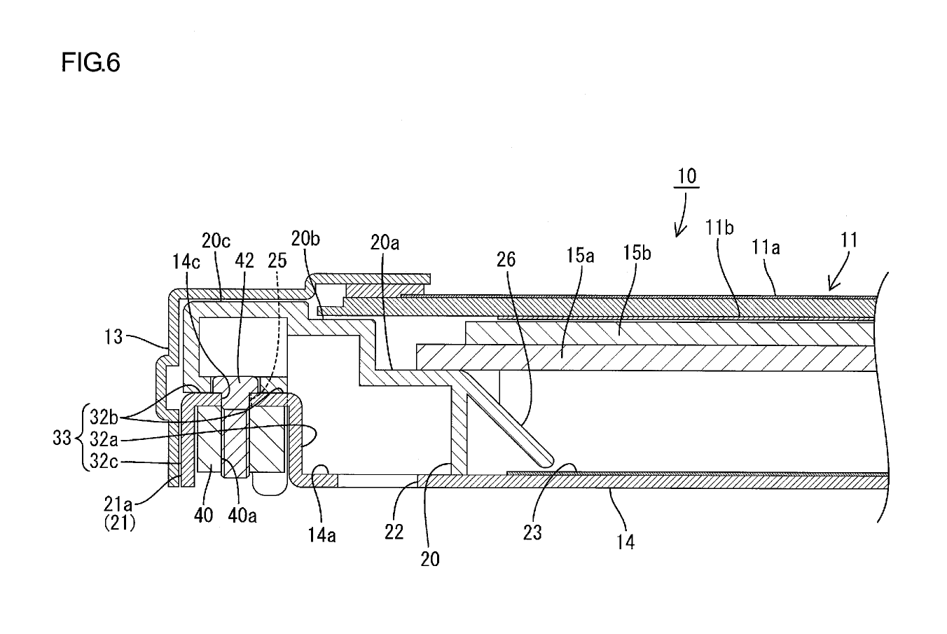

FIG. 1 is an exploded perspective view illustrating a general construction of the television receiver according to the first embodiment. FIG. 2 is an exploded perspective view illustrating a general construction of the liquid crystal display device provided in the television receiver shown in FIG. 1. FIG. 3 is a cross-sectional view of a main portion of the liquid crystal display device in FIG. 2 along the short-side direction. FIG. 4 is a cross-sectional view of a main portion of the liquid crystal display device in FIG. 2 along the long-side direction. FIG. 5 is an enlarged cross-sectional view of a main portion of the liquid crystal display device in FIG. 3. FIG. 6 is an enlarged cross-sectional view of a main portion of the liquid crystal display device in FIG. 4.

As illustrated in FIG. 1, the television receiver TV of the present embodiment includes the liquid crystal display device 10, front and rear cabinets Ca, Cb that house the liquid crystal display device 10 therebetween, a power source P, a tuner T and a stand S. An overall shape of the liquid crystal display device (display device) 10 is a landscape rectangular. The liquid crystal display device 10 is housed in a vertical position. As illustrated in FIG. 2, it includes a liquid crystal panel 11 as a display panel, and a backlight device 12 (lighting device), which is an external light source. They are integrally held by a bezel 13 and the like.

Next, the liquid crystal panel 11 and the backlight device 12 included in the liquid crystal display device 10 will be explained (see FIGS. 2 to 4).

The liquid crystal panel (display panel) 11 is constructed such that a pair of glass substrates is bonded together with a predetermined gap therebetween and liquid crystal is sealed between the glass substrates. On one of the glass substrates, switching components (e.g., TFTs) connected to source lines and gate lines that are perpendicular to each other, pixel electrodes connected to the switching components, and an alignment film are provided. On the other substrate, color filter having color sections such as R (red), G (green) and B (blue) color sections arranged in a predetermined pattern, counter electrodes, and an alignment film are provided. Polarizing plates 11a, 11b are attached to outer surfaces of the substrates (see FIGS. 3 and 4).

As illustrated in FIG. 2, the backlight device 12 includes a chassis 14, a diffuser plate 15a, a plurality of optical sheets 15b and frames 16. The chassis 14 has a substantially box-shape and an opening on the light emitting side (on the liquid crystal panel 11 side). The diffuser plate 15a are arranged so as to cover the opening 14b of the chassis 14. The optical sheets 15b are arranged between the diffuser plate 15a and the liquid crystal panel 11. The frames 16 arranged along the long sides of the chassis 14 hold the long-side edges of the diffuser plate 15a to the chassis 14. The long-side edges of the diffuser plate 15a are sandwiched between the chassis 14 and the frames 16. Cold cathode tubes (light sources) 17, lamp clips 18, relay connectors 19 and lamp holders 20 are installed in the chassis 14. The lamp clips 18 are provided for mounting the cold cathode tube 17 to the chassis 14. The relay connectors 19 are connected to ends of the cold cathode tubes 17 for making electrical connection. The lamp holders 20 collectively cover ends of the cold cathode tubes 17 and the relay connectors 19. A light emitting side of the backlight device 12 is a side closer to the diffuser plate 15a than the cold cathode tubes 17.

The chassis 14 is made of metal. It is prepared by processing a metal plate into a substantially shallow box shape. It includes a rectangular bottom plate and outer rims 21 (short-side outer rims 21a and long-side outer rims 21b), each of which extends upright from the corresponding side of the bottom plate and is folded in a substantially U shape. The bottom plate of the chassis 14 has a plurality of mounting holes 22 at two ends of the bottom plate in the long-side edges thereof. The relay connectors 19 are mounted in the mounting holes 22. As illustrated in FIG. 3, fixing holes 14c are provided in the upper surface of the chassis 14 along the folded outer rims 21b to bind the bezel 13, the frames 16 and the chassis 14 together with screws and the like.

A light reflecting sheet 23 is disposed on an inner surface of the bottom plate of the chassis 14 (on a side that faces the cold cathode tubes 17). The light reflecting sheet 23 is a synthetic resin sheet having a surface in white color that provides high light reflectivity. It is placed so as to cover almost entire inner surface of the bottom plate of the chassis 14. As illustrated in FIG. 3, long-side edges of the light reflecting sheet 23 are lifted so as to cover the folded outer rims 21b of the chassis 14 and sandwiched between the chassis 14 and the diffuser plate 15a. With this light reflecting sheet 23, light emitted from the cold cathode tubes 17 is reflected toward the diffuser plate 15a.

On the opening 14b side of the chassis 14, the diffuser plate 15a and the optical sheets 15b are provided. The diffuser plate 15a includes a synthetic resin plate containing scattered light diffusing particles. It diffuses linear light emitted from the cold cathode tubes 17 that is a tubular light source. The short-side edges of the diffuser plate 15a are placed on the first surface 20a of the holder 20 as described above, and does not receive a vertical force. As illustrated in FIG. 3, the long-side edges of the diffuser plate 15a are sandwiched between the chassis 14 (the reflecting sheet 23) and the frame 16 and fixed.

The optical sheets 15b provided on the diffuser plate 15a include a diffuser sheet, a lens sheet and a reflecting type polarizing plate layered in this order from the diffuser plate 15a side. Light emitted from the cold cathode tubes 17 passes through the diffuser plate 15a and the optical sheets 15b convert the light to planar light. The liquid crystal display panel 11 is disposed on the top surface of the top layer of the optical sheets 15b. The optical sheets are held between the diffuser plate 15a and the liquid crystal panel 11.

Each cold cathode tube 17 has an elongated tubular shape. A plurality of the cold cathode tubes 17 are installed in the chassis 14 such that they are arranged parallel to each other with the long-side direction thereof (the axial direction) aligned along the long-side direction of the chassis 14 (see FIG. 2). Each end of each cold cathode tube 17 is fitted in the corresponding relay connector 19. The holders 20 are mounted so as to cover the relay connectors 19.

The diameter of each cold cathode tube 17 used in this embodiment is 4.0 mm. The distance between the cold cathode tubes 17 and the bottom plate 14a of the chassis 14 is 0.8 mm. The distance between the adjacent cold cathode tubes 17 is 16.4 mm. The distance between the cold cathode tubes 17 and the diffuser plate 15a is 2.7 mm. In this backlight device 12, distances between the components are defined so as to reduce the thickness of the backlight device 12. Especially, the distance between the cold cathode tubes 17 and the diffuser plate 15a and the distance between the cold cathode tubes 17 and the light reflecting sheet 23 are reduced. Because of the thickness reduction of the lighting device 12, the liquid crystal display device 10 and that of the television receiver TV are provided with the following thickness. The thickness of the liquid crystal display device 10 (i.e., the thickness between the front surface of the liquid crystal panel 11 and the back surface of the backlight device 12) is 16 mm. The thickness of the television receiver TV (i.e., the thickness between the front surface of the front cabinet Ca and the back surface of the rear cabinet Cb) is 34 mm. Namely, a thin television receiver is provided.

The holders 20 that cover the ends of the cold cathode tubes 17 are made of white synthetic resin. Each of them has an elongated substantially box shape that extends along the short side of the chassis 14. As illustrated in FIG. 4, each holder 20 has steps on the front side such that the diffuser plate 15a and the liquid crystal panel 11 are held at different levels. A part of the holder 20 is placed on top of apart of the corresponding folded outer rim 21a of the chassis 14 and forms a side wall of the backlight device 12 together with the folded outer rim 21a. An insertion pin 24 projects from a surface of the holder 20 that faces the folded outer rim 21a of the chassis 14. The holder 20 is mounted to the chassis 14 by inserting the insertion pin 24 into the insertion hole 25 provided in the top surface of the folded outer rim 21a of the chassis 14.

The steps of the holder 20 include three surfaces parallel to the bottom plate of the chassis 14. The short edge of the diffuser plate 15a is placed on the first surface 20a located at the lowest level. A sloped cover 26 extends from the first surface 20a toward the bottom plate of the chassis 14. A short edge of the liquid crystal panel 11 is placed on the second surface 20b of the steps of the holder 20. The third surface 20c located at the highest level of the steps of the holder 20 is provided such that it overlaps the folded outer rim 21a of the chassis 14 and comes in contact with the bezel 13.

As illustrated in FIG. 5, each long-side outer rim 21b has a long-side folded portion (folding configuration) 31 that has a substantially U shape. The long-side folded portion 31 comprises a first inner plate portion 30a, a first upper plate portion 30b and a first outer plate portion 30c. The first inner plate portion 30a is extended upwardly substantially vertically from the bottom plate 14a of the chassis 14. The first upper plate portion 30b is bent from the first inner plate portion 30a toward the outside of the chassis 14 so as to be substantially parallel to the bottom plate 14a. The first outer plate portion 30c is bent substantially vertically from the first upper plate portion 30b toward the bottom plate 14a. A height from the bottom plate 14a to the first upper plate portion 30b corresponds to a maximum height of the chassis 14 and is set to be 8 mm.

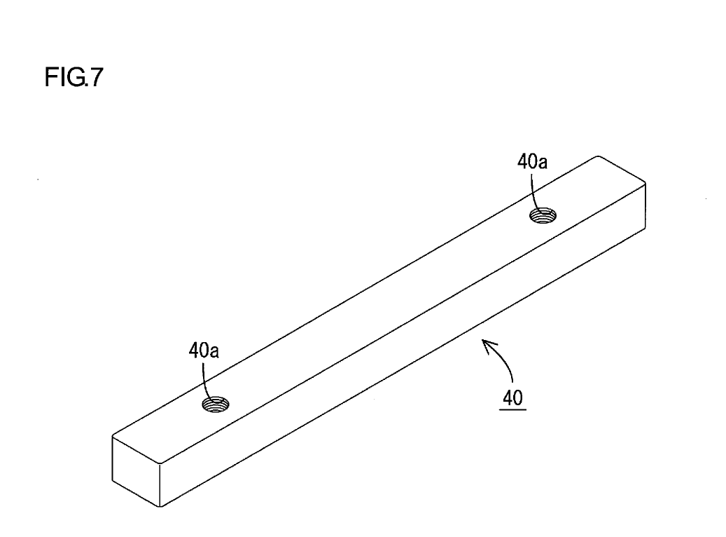

A reinforcing plate (core member) 40 is attached to an inner surface of the folded part corresponding to the first upper plate portion 30b of the long-side folded portion 31. The reinforcing plate 40 is extended along a longitudinal direction of the long-side folded portion 31. The reinforcing plate 40 is made of a metal. As illustrated in FIG. 7, the reinforcing plate 40 is formed in an elongated quadrangular prism and a plurality of fixing holes 40a for fixing the reinforcing plate are formed in the reinforcing plate 40 in its longitudinal direction so as to be penetrated therethrough vertically. Other than galvanized steel, the material of the reinforcing plate 40 may be appropriately selected from iron alloy having corrosion resistance or stainless and others.

The reinforcing plate 40 is provided in the long-side folded portion 31 such that the upper surface of the reinforcing plate 40 in its elongated direction is contacted to the inner surface of the folded part corresponding to the first upper plate 30b with a plane surface contact and a gap is formed between each of two longitudinal side surfaces of the reinforcing plate 40 and each of the first inner plate portion 30a and the first outer plate portion 30c of the long-side folded portion 31, respectively. The reinforcing plate 40 is provided inside the long-side folded portion 31. The reinforcing plate 40 is attached to the long-side outer rim 21b by inserting a screw (fixing member, screw) 42 from the outside of the bezel 13 (the upper side in FIG. 5) through the frame 16 and the fixing hole 14c in the long-side outer rim 21b in this order to be screwed into the fixing hole 40a in the reinforcing plate 40.

As illustrated in FIG. 6, each short-side outer rim 21a of the chassis 14 has a short-side folded portion (folding configuration) 33 that has a substantially U shape. The short-side folded portion 33 comprises a second inner plate portion 32a, a second upper plate portion 32b and a second outer plate portion 32c. The second inner plate portion 32a is extended upwardly substantially vertically from the bottom plate 14a of the chassis 14. The second upper plate portion 32b is bent from the second inner plate portion 32a so as to be substantially parallel to the bottom plate 14a of the chassis 14. The second outer plate portion 32c is bent substantially vertically from the second upper plate portion 32b toward the bottom plate 14a of the chassis 14.

The reinforcing plate 40 is provided on an inner surface of the folded part corresponding to the second upper plate portion 32b of the short-side folded portion 33. The upper surface of the reinforcing plate 40 in its elongated direction is contacted to the inner surface of the folded part corresponding to the second upper plate 32b with a plane surface contact and a gap is formed between each of two longitudinal side surfaces of the reinforcing plate 40 and each of the second inner plate portion 32a and the second outer plate portion 32c of the short-side folded portion 33, respectively. The reinforcing plate 40 is provided inside the short-side folded portion 33. The reinforcing plate 40 is attached to the short-side outer rim 21a by inserting a screw 42 from the outside of the folded part of the short-side outer rim 21a (the upper side in FIG. 6) to be screwed into the fixing hole 40a in the reinforcing plate 40.

The television receiver TV, the liquid crystal display device 10 and the backlight device 12 of the present embodiment including the above-described configurations provide the following operational effects.

The chassis 14 provided in the backlight device 12 of the present embodiment has the flat bottom plate 14a and the outer rims 21 that are formed on the edges of the bottom plate 14a. The outer rims 21 comprise long-side outer rims 21b each having the long-side folded portion 31 and short-side outer rims 21a each having the short-side folded portion 33. Further, at the long-side outer rims 21b and the short-side outer rims 21a, the reinforcing plate 40 extending in the longitudinal direction of the long-side outer rim 21b and the short-side outer rim 21a is provided in each of the folded parts of long-side folded portion 31 and the short-side folded portion 33.

Since the reinforcing plate 40 is attached to the outer rims 21, the strength of the outer rims 21 is improved and distortion of the whole chassis 14 is suppressed. Especially in the present embodiment, the maximum vertical height of the outer rims 21 with respect to the bottom plate 14a is set to be 8.0 mm that is a distance between the first upper plate portion 30b of the long-side outer rim 21b and the bottom plate 14a. Therefore, in the outer rim 21 that is made thinner such that its height from the bottom plate 14a is set to be 10.0 mm or less, the above-described configuration with the attachment of the reinforcing plate 40 is especially effective for applying strength to the outer rim 21.

Further, the reinforcing plate 40 is attached in each of the folded parts of the long-side folded portion 31 and the short-side folded portion 33 of the long-side outer rim 21b and the short-side outer rim 21a. The long-side folded portion 31 has a space in its folded part. The space is surrounded by three walls that are the first inner plate portion 32a, the first upper plate portion 32b and the first outer plate portion 30c. Similarly, the short-side folded portion 33 has a space in its folded part. The space is surrounded by three walls that are the second inner plate portion 32a, the second upper plate portion 32b and the second outer plate portion 32c. The reinforcing plate 40 is attached in the space that is previously formed and the space is effectively used for the reinforcing plate 40. Accordingly, a different space for arranging the reinforcing plate 40 is not necessary to be prepared. This enables the chassis 14 to be reinforced without hindering decrease in the thickness of the backlight device 12.

Especially in the present embodiment, at the long-side outer rim 21b and the short-side outer rim 21a, the reinforcing plate 40 is provided inside the long-side folded portion 31 and the short-side folded portion 31 that is formed in a substantially U shape.

In this case, at each of the long-side outer rim 21b and the short-side outer rim 21a, a space is formed by the long-side folded portion 31 and the short-side folded portion 33 so as to be surrounded by the three walls that form the substantially U shape. The reinforcing plate 40 is fitted in the space so as to be provided inside the long-side folded portion 31 and the short-side folded portion 33. Accordingly, a different space for arranging the reinforcing plate 40 is not necessary to be prepared, and the thickness reduction of the backlight device 12 and the reinforcement of the outer rims 21 are achieved.

In the present embodiment, the reinforcing plate 40 is fixed to the outer rim 21 by the screw 42 that is inserted through the reinforcing plate 40 and the first upper plate portion 30b or the second upper plate portion 32b forming the first folded portion 31, 33 of the outer rim 21.

Due to the configuration in which the reinforcing plate 40 is attached to the outer rim 21 by the screw 42, the attachment work is simplified. This enables the reinforcement of the outer rims 21 without reducing efficiency of the assembling work.

Especially in the present embodiment, at the long-side outer rim 21b, the screw 42 is inserted through the bezel 13 that integrally holds the backlight device 12 and the liquid crystal panel 11 and the reinforcing plate 40.

According to this configuration, one screw 42 is inserted through the bezel 13, the outer rim 21 and the reinforcing plate 40 to fix them collectively. This improves efficiency of the assembling work, and a different space for arranging a fixing member for fixing the components is not necessary to be prepared. This configuration is appropriately applied to the thin chassis 14 according to the present embodiment.

In the present embodiment, the reinforcing plate 40 is attached to the long-side outer rim 21b of the chassis 14.

The distortion of the chassis 14 is easier to be caused along its long-side direction. The reinforcing plate 40 is formed at the long-side outer rim 21b that extends in the long-side direction of the chassis 14, and therefore, the distortion of the chassis 14 is appropriately suppressed.

Especially, in the present embodiment, the reinforcing plate 40 is attached to the short-side outer rim 21a of the chassis 14.

The attachment of the reinforcing plate 40 to the short-side outer rim 21a of the chassis 14 further improves the strength of the whole reinforcing plate 40 and surely suppresses the distortion of the chassis 14.

In the present embodiment, the distance between the cold cathode tubes 17 and the bottom plate 14a of the chassis 14 is quite small, for example, 0.8 mm.

Slight leakage is occurred from the cold cathode tubes 17 to the chassis 14 and the leakage amount is inversely proportional to the distance between the cold cathode tubes 17 and the chassis 14. Therefore, if the distortion is caused in the chassis 14 and the distance between each cold cathode tube 17 and the bottom plate 14a is different, the leakage amount is varied with each cold cathode tube 17. In the present embodiment, the distance between the cold cathode tubes 17 and the bottom plate 14a of the chassis 14 is set to be 0.8 mm. If the distance between the cold cathode tubes 17 and the bottom plate 14a is quite small, for example, 2.5 mm or less, the distance change amount between the two components due to the distortion of the chassis 14 with respect to the design distance between the two components is great. This increases variation of current flowing in the cold cathode tubes 17 and therefore, brightness of the cold cathode tubes 17 may be different in each cold cathode tube 17.

However, the use of the chassis 14 having the outer rims 21 with the reinforcing plate 40 according to the present invention suppresses the distortion of the chassis 14. Therefore, the configuration of the present invention provides effects especially in the thin backlight device 12, that is, in a case in that the distance between the cold cathode tubes 17 and the bottom plate 14a of the chassis 14 is small.

<Modifications>

The first embodiment of the present invention has been explained, and the attachment examples of the reinforcing plate 40 to the long-side outer rim 21b or the short-side outer rim 21a are not limited to those described therein and the following configurations are included in the present invention.

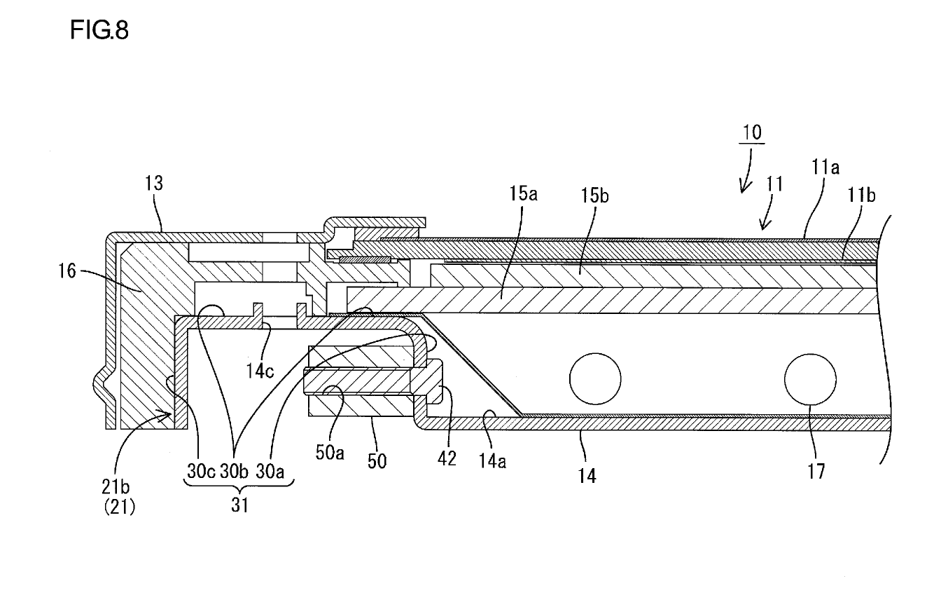

For example, as illustrated in FIG. 8, at the long-side outer rim 21b, a reinforcing plate 50 may be attached to the first inner plate portion 30a of the long-side folded portion 31, that is a portion of the long-side folded portion 31 closer to the bottom plate 14a of the chassis 14. In such a case, the screw 42 is inserted from the outside of the folded part corresponding to the first inner plate portion 30a to be screwed to a fixing hole 50a in the reinforcing plate 50. Accordingly, the reinforcing plate 50 is fixed to the long-side outer rim 21b.

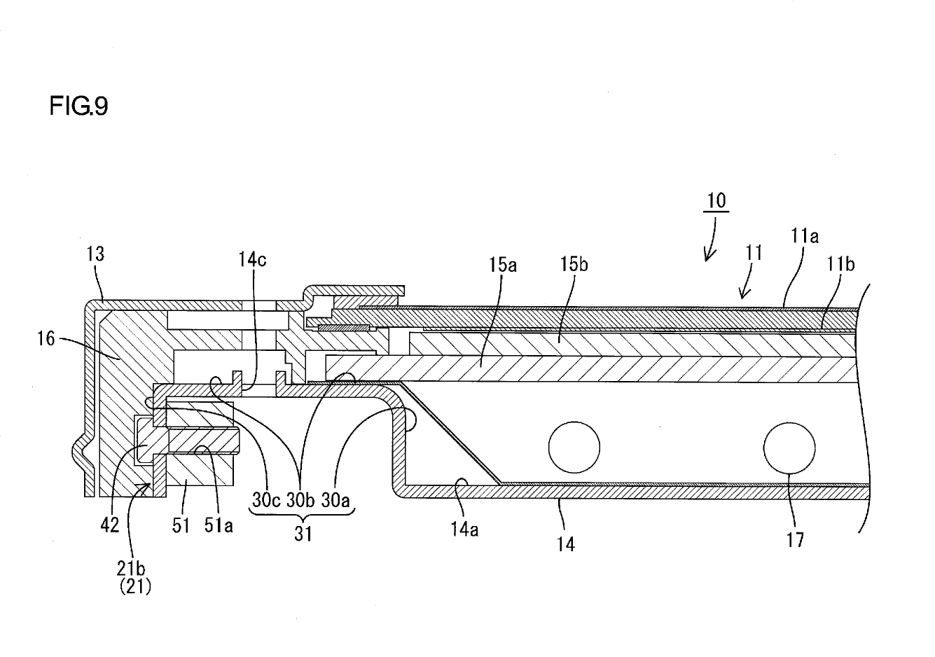

As illustrated in FIG. 9, at the long-side outer rim 21b, a reinforcing plate 51 may be attached to the first outer plate portion 30c of the long-side folded portion 31, that is a portion of the long-side folded portion 31 closer to an outer edge of the chassis 14 (far away from the bottom plate 14a). In such a case, the screw 42 is inserted from the outside of the folding part corresponding to the first outer plate portion 30c to be screwed to a fixing hole 51a in the reinforcing plate 51. Accordingly, the reinforcing plate 51 is fixed to the long-side outer rim 21b.

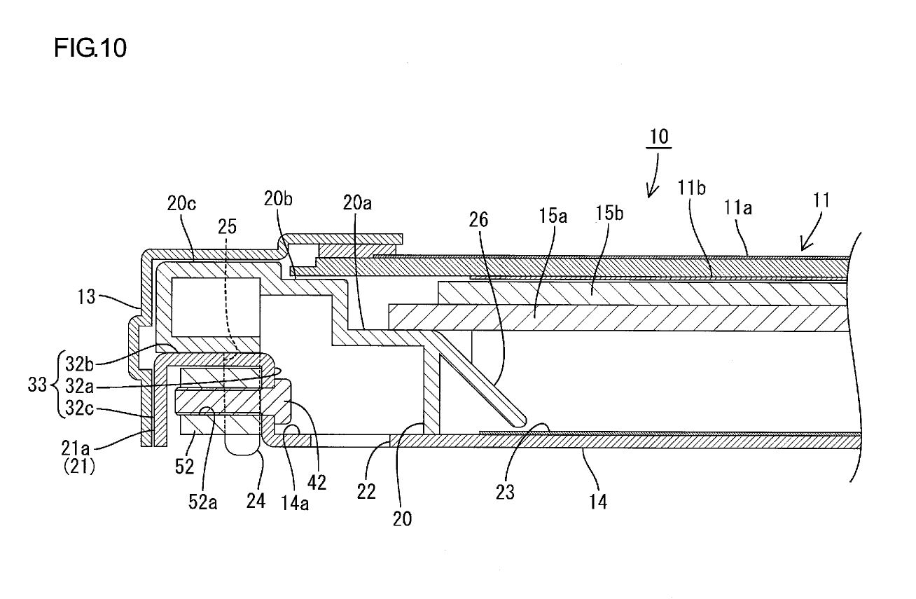

As illustrated in FIG. 10, at the short-side outer rim 21a, a reinforcing plate 52 may be attached to the second inner plate portion 32a of the short-side folded portion 33, that is a portion of the short-side folded portion 33 closer to the bottom plate 14a of the chassis 14. In such a case, the screw 42 is inserted from the outside of the folded part corresponding to the second inner plate portion 32a to be screwed to a fixing hole 52a in the reinforcing plate 52. Accordingly, the reinforcing plate 52 is fixed to the short-side outer rim 21a.

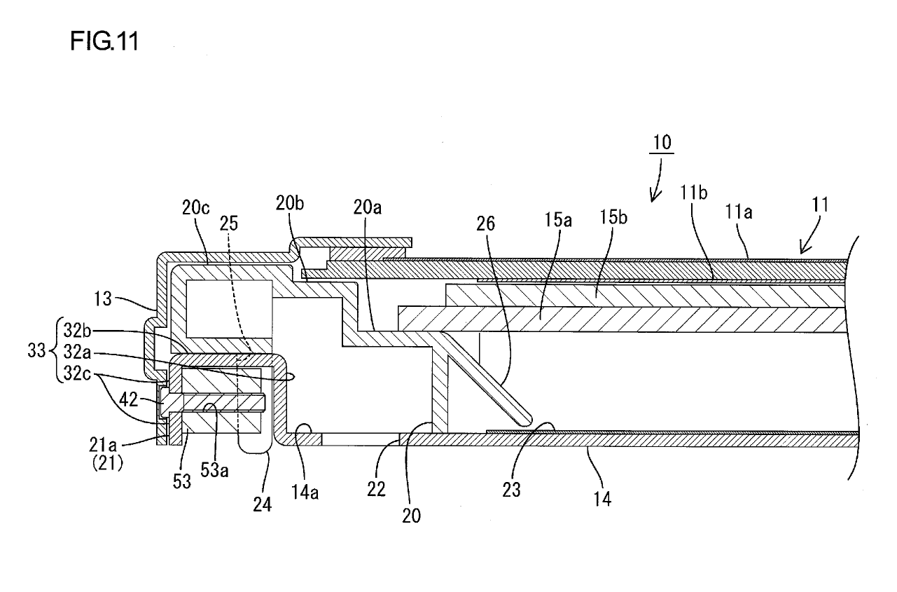

As illustrated in FIG. 11, at the short-side outer rim 21a, a reinforcing plate 53 may be attached to the second outer plate portion 32c of the short-side folded portion 33, that is a portion of the short-side folded portion 33 closer to an outer edge of the chassis 14 (far away from the bottom plate 14a). In such a case, the screw 42 is inserted from the outside of the folding part corresponding to the second outer plate portion 32c to be screwed to a fixing hole 53a in the reinforcing plate 53. Accordingly, the reinforcing plate 53 is fixed to the short-side outer rim 21a.

### Second Embodiment

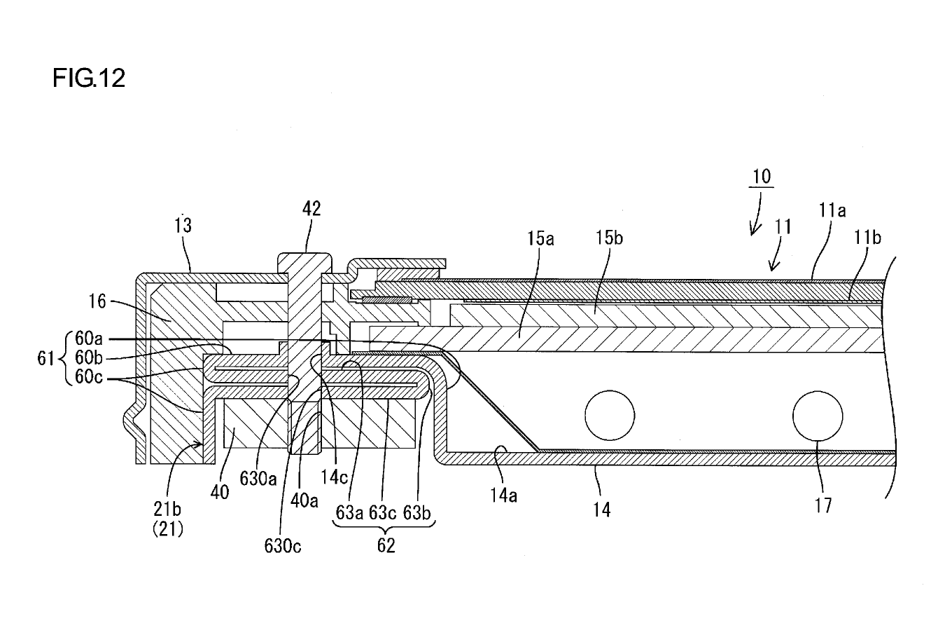

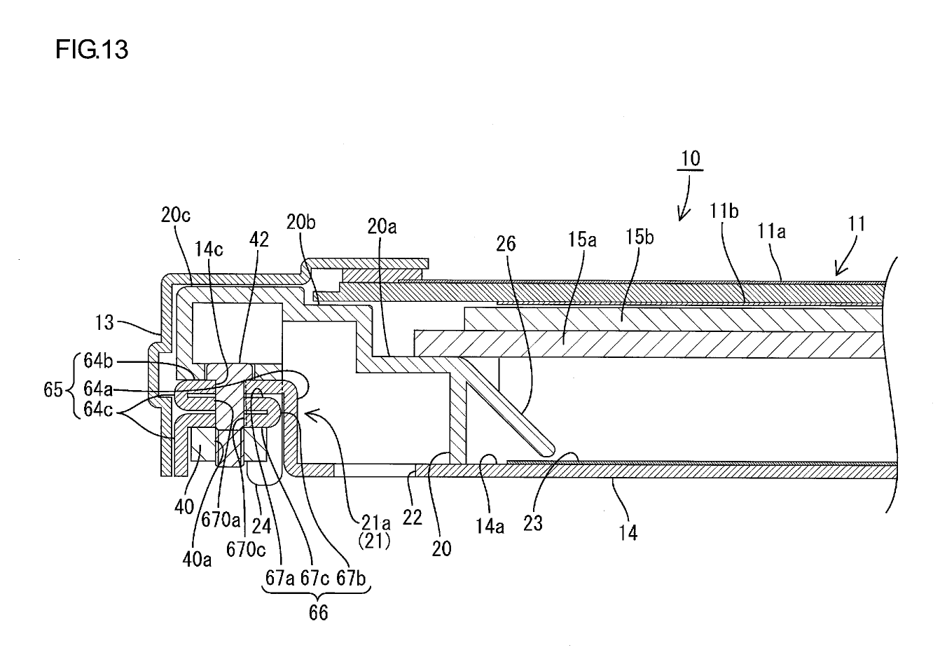

Next, a second embodiment of the present invention will be explained with reference to FIG. 12 and FIG. 13. In the second embodiment, the outer rims have a double folding configuration, and other configurations are same as the above embodiment. The same parts as the above embodiment are indicated by the same symbols and the explanation thereof is omitted.

FIG. 12 is an enlarged cross-sectional view illustrating a cross-sectional configuration of a main portion along a short-side direction of the liquid crystal display device according to a second embodiment of the present invention. FIG. 13 is an enlarged cross-sectional view illustrating a cross-sectional configuration of a main portion along a long-side direction of the liquid crystal display device.

The chassis 14 is formed in a substantially shallow box shape with plating. It includes a flat bottom plate 14a and outer rims 21 (the short-side outer rims 21a in the short-side direction and the long-side outer rims 21b in the long-side direction), each of which extends upright from the corresponding side of the bottom plate 14a and is formed in a substantially U shape.

The long-side outer rim 21b of the chassis 14 comprises a long-side first folded portion (first folded portion) 61 having a substantially U shape, as illustrated in FIG. 12. The long-side first folded portion 61 comprises a first inner plate portion 60a, a first upper plate portion 60b and a first outer plate portion 60c. The first inner plate portion 60a is extended upwardly substantially vertically from the bottom plate 14a of the chassis 14. The first upper plate portion 60b is bent from the first inner plate portion 60a toward the outside of the chassis 14 so as to be substantially parallel to the bottom plate 14a. The first outer plate portion 60c is bent substantially vertically from the first upper plate portion 60b toward the bottom plate 14a. A fixing hole 14c is formed in the first upper plate portion 60b of the long-side first folded portion. The first outer plate portion 60c of the long-side first folded portion 61 is further bent in a substantially U shape at a position closer to the first upper plate portion 60b to form a long-side second folded portion 62 (second folded portion) 62. In the present embodiment, the long-side second folded portion 62 is projected from the first outer plate portion 60c so as to overlap the first upper plate portion 60b.

The long-side second folded portion 62 comprises a second upper plate portion 63a, a second inner plate portion 63b and a second lower plate portion 63c. The second upper plate portion 63a is bent substantially vertically from the first outer plate portion 60c along the first upper plate portion 60b. The second inner plate portion 63b is bent from the second upper plate portion 63a so as to be substantially parallel to the first outer plate portion 60c. The second lower plate portion 63c is bent substantially vertically from the second inner plate portion 63b toward the first outer plate portion 60c. There is a small gap between the second upper plate portion 63a of the long-side second folded portion 62 and the first upper plate portion 60b of the long-side first folded portion 61. Also, there is a small gap between the second inner plate portion 63b and the first inner plate portion 60a. In other words, the long-side second folded portion 62 is provided so as to extend in a longitudinal direction (a long side of the chassis 14) of the long-side outer rim 21b so that the plate portions 63a, 63b, 63c of the long-side second folded portion 62 do not contact the long-side first folded portion 61. The long-side second folded portion 62 is formed in the folded part of the long-side first folded portion 61 so as to be closer to the first upper plate portion 60b of the long-side first folded portion 61. Screw holes 630a, 630c are formed in the corresponding portions of the second upper plate portion 63a and the second lower plate portion 63c of the long-side second folded portion 62 so as to overlap the fixing hole 14c.

As described above, in the present embodiment, the long-side first folded portion 61 forms an outer appearance of the long-side outer rim 21b. The long-side second folded portion 62 is formed by folding a part of the first outer plate portion 60c of the long-side first folded portion 61 and provided inside the substantially U shape of the long-side first folded portion 61.

Further, the reinforcing plate 40 is attached to the second lower plate portion 63c of the long-side second folded portion 62. The reinforcing plate 40 is provided in the folded part of the long-side first folded portion 61. An upper surface of the reinforcing plate 40 is contacted to a lower surface of the second lower plate portion 63c of the long-side second folded portion 62 with a plane surface contact. A small gap is formed between each of two longitudinal side surfaces of the reinforcing plate 40 and each of the first inner plate portion 60a and the first outer plate portion 60c of the long-side first folded portion 61, respectively. The reinforcing plate 40 is provided inside the long-side first folded portion 61. The reinforcing plate 40 is attached to the long-side outer rim 21b by inserting the screw 42 from the outside of the bezel 13 through the frame 16, the fixing hole 14c in the long-side first folded portion 61 and the screw holes 630a, 630c in the long-side second folded portion 62 in this order to be screwed into the fixing hole 40a in the reinforcing plate 40.

As illustrated in FIG. 13, each short-side outer rim 21a of the chassis 14 has a short-side first folded portion (first folded portion) 65 that has a substantially U shape. The short-side first folded portion 65 comprises a third inner plate portion 64a, a third upper plate portion 64b and a third outer plate portion 64c. The third inner plate portion 64a is extended upwardly substantially vertically from the bottom plate 14a of the chassis 14. The third upper plate portion 64b is bent from the third inner plate portion 64a so as to be substantially parallel to the bottom plate 14a of the chassis 14. The third outer plate portion 64c is bent substantially vertically from the third upper plate portion 64b toward the bottom plate 14a of the chassis 14. The fixing hole 14c is formed in the third upper plate portion 64b of the short-side first folded portion 65. The third outer plate portion 64c that forms the short-side first folded portion 65 is further bent at a position closer to the third upper plate portion 64b in a substantially U shape. Accordingly, a short-side second folded portion (second folded portion) 66 is formed. In the present embodiment, the short-side second folded portion 36 is projected from the third outer plate portion 34c so as to overlap the third upper plate portion 34b.

The short-side second folded portion 66 comprises a fourth upper plate portion 67a, a fourth inner plate portion 67b and a fourth lower plate portion 67c. The fourth upper plate portion 67a is bent substantially vertically from the third outer plate portion 64c along the third outer plate portion 64b. The fourth inner plate portion 67b is bent from the fourth upper plate portion 67a so as to be substantially parallel to the third outer plate portion 64c. The fourth lower plate portion 67c is bent substantially vertically from the fourth inner plate portion 67b toward the third outer plate portion 64c. There is a small gap between the fourth upper plate portion 67a of the short-side second folded portion 66 and the third upper plate portion 64b of the short-side first folded portion 65. Also, there is a small gap between the fourth inner plate portion 67b and the third inner plate portion 64a. In other words, the short-side second folded portion 66 is provided so as to extend in a longitudinal direction (a short side of the chassis 14) of the short-side outer rim 21a so that the plate portions 67a, 67b, 67c of the short-side second folded portion 66 do not contact the short-side first folded portion 65. The short-side second folded portion 66 is formed in the folded part of the short-side first folded portion 65 so as to be closer to the third upper plate portion 64b of the short-side first folded portion 65. Screw holes 670a, 670c are formed in the corresponding portions of the fourth upper plate portion 67a and the fourth lower plate portion 67c of the short-side second folded portion 66 so as to overlap the fixing hole 14c.

As described above, in the present embodiment, the short-side first folded portion 65 forms an outer appearance of the short-side outer rim 21a. The short-side second folded portion 66 is formed by folding a part of the third outer plate portion 64c of the short-side first folded portion 65 and provided inside the substantially U shape of the short-side first folded portion 65.

Further, the reinforcing plate 40 is attached to the fourth lower plate portion 67c of the short-side second folded portion 66. The reinforcing plate 40 is provided in the folded part of the short-side first folded portion 65. An upper surface of the reinforcing plate 40 is contacted to a lower surface of the fourth lower plate portion 67c of the short-side second folded portion 66 with a plane surface contact. A small gap is formed between each of two longitudinal side surfaces of the reinforcing plate 40 and each of the third inner plate portion 64a and the third outer plate portion 64c of the short-side first folded portion 65, respectively. The reinforcing plate 40 is provided inside the short-side first folded portion 65.

The reinforcing plate 40 is attached to the short-side outer rim 21a by inserting the screw 42 from the outside of the short-side first folded portion 65 through the fixing hole 14c and the screw holes 670a, 670c in this order to be screwed into the fixing hole 40a in the reinforcing plate 40.

The backlight device 12 of the second embodiment having the above-described configuration has following operational effects.

The long-side outer rim 21b of the chassis 14 provided in the backlight device 12 according to the second embodiment has the double folding configuration comprising the long-side first folded portion 61 and the long-side second folded portion 62 that is formed by folding a part of the corresponding long-side first folded portion 61. The short-side outer rim 21a has the double folding configuration comprising the short-side first folded portion 65 and the short-side second folded portion 66 that is formed by folding a part of the short-side first folded portion 65. Further, the reinforcing plate 40 is provided in the folded part of each of the first folded portions 61, 65.

Thus, the outer rim 21 (the long-side outer rim 21b and the short-side outer rim 21a) to which the reinforcing plate 40 is attached has the double folding configuration comprising the first folded portion 61, 65 and the second folded portion 62, 66. This improves the strength of the outer rim 21 and suppresses the distortion of the chassis 14 more surely. The reinforcing plate 40 is arranged in the folded part of the first folded portion 61, 65, that is a previously formed space that is surrounded by the folded part. Therefore, a different space for arranging the reinforcing plate 40 is not necessary to be prepared and the thickness reduction of the backlight device 12 is not hindered.

Especially in the present embodiment, the first folded portion 61, 65 is folded in a substantially U shape and the second folded portion 62, 66 is formed inside the substantially U shape of the first folded portion 61, 65.

The second folded portion 62, 66 is formed inside the substantially U shape of the first folded portion 61, 65 (in the folded part of the first folded portion 61, 65), that is, in the space generated by forming the first folded portion 61, 65. Therefore, a new different space for forming the second folded portion 64, 66 is not necessary to be prepared. This enables the thickness reduction of the backlight device 12 and reinforcement of the outer rims 21.

<Modifications>

The second embodiment of the present invention has been explained, and the configurations of the first folded portions 61, 65 and the second folded portions 62, 66 and the attachment configuration of the reinforcing plate 40 are not limited thereto and the following configurations are included in the present invention.

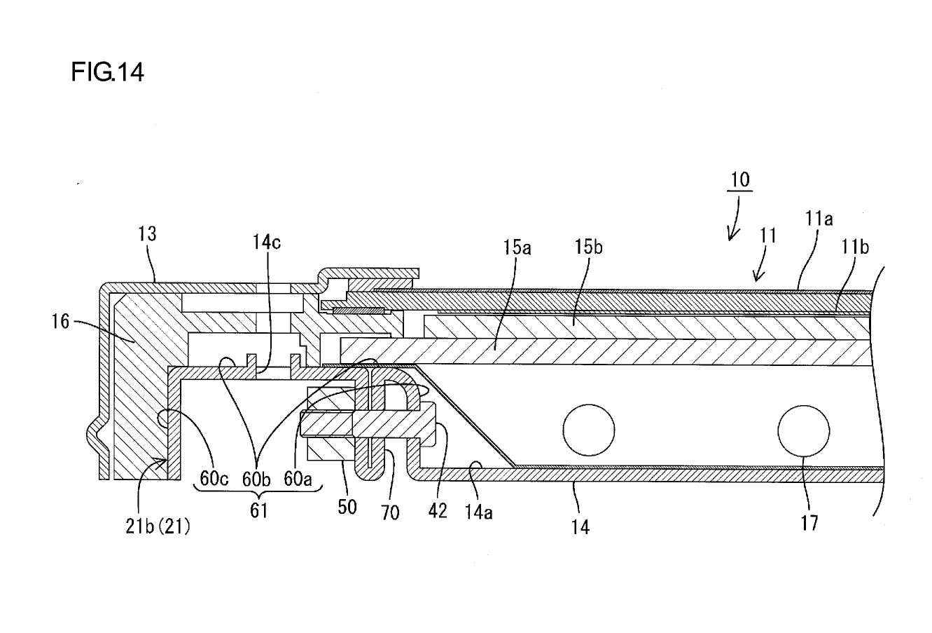

For example, as illustrated in FIG. 14, the long-side first folded portion 61 and a long-side second folded portion 70 are formed at the long-side outer rim 21b. The second folded portion 70 is formed by folding the first upper plate portion 60b of the long-side first folded portion 61 in a substantially U shape. Specifically, the long-side second folded portion 70 is formed in the folded part of the long-side first folded portion 61 so as to be closer to the first inner plate portion 60a (closer to the bottom plate 14a of the chassis 14). The long-side first folded portion 61 forms an outer appearance of the long-side outer rim 21b and the long-side second folded portion 70 is formed by folding a part of the first upper plate portion 60b of the long-side first folded portion 61 and provided in the long-side first folded portion 61 so as to overlap the first outer plate portion 60c. The reinforcing plate 50 may be provided in the folded part of the long-side first folded portion 61 (inside the long-side first folded portion 61) so as to be contacted to a surface of the long-side second folded portion 70 facing the first outer plate portion 60c with a plane surface contact. The reinforcing plate 50 may be fixed to the long-side second folded portion 70 by the screw 42 that is inserted from the first inner plate portion 60a.

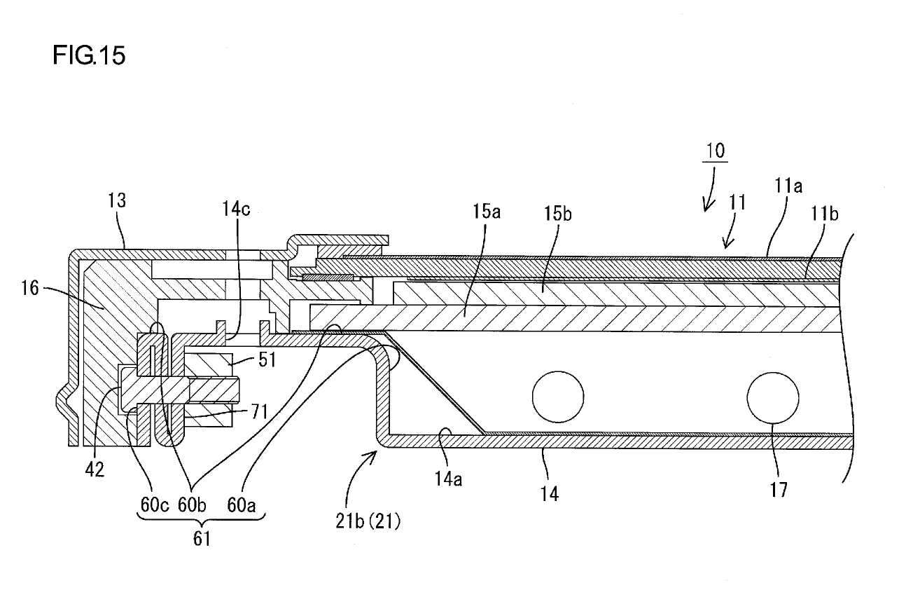

As illustrated in FIG. 15, the long-side first folded portion 61 and a long-side second folded portion 71 are formed at the long-side outer rim 21b. The long-side second folded portion 71 is formed by folding the first upper plate portion 60b of the long-side first folded portion 61 in a substantially U shape. Specifically, the long-side second folded portion 71 is formed in the long-side first folded portion 61 so as to be closer to the first outer plate portion 60c (far away from the bottom plate 14a of the chassis 14). The long-side first folded portion 61 forms an outer appearance of the long-side outer rim 21b and the long-side second folded portion 71 is formed by folding a part of the first upper plate portion 60b of the long-side first folded portion 61 and provided in the long-side first folded portion 61 so as to overlap the first outer plate portion 60c. The reinforcing plate 51 may be provided in the folded part of the long-side first folded part 61 (inside the long-side first folded portion 61) so as to be contacted to a surface of the long-side second folded portion 71 facing the first inner plate portion 60a with a plane surface contact. The reinforcing plate 51 may be fixed to the long-side second folded portion 71 by the screw 42 that is inserted from the first outer plate portion 60c.

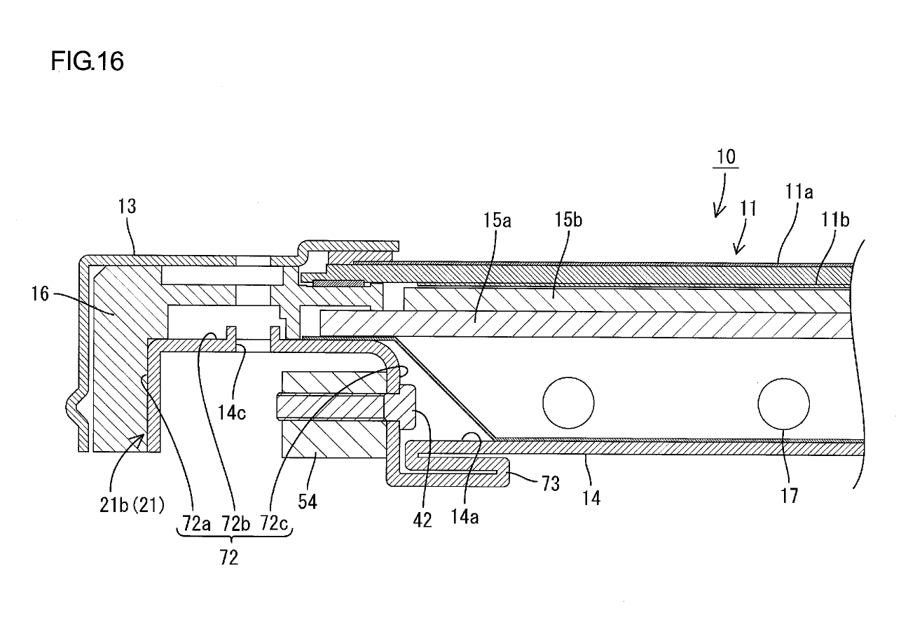

As illustrated in FIG. 16, a long-side first folded portion 72 and a long-side second folded portion 73 are formed at the long-side outer rim 21b. The long-side second folded portion 73 is formed by folding an end of the inner plate portion 72c of the long-side first folded portion 72 in a substantially U shape and projected from the inner plate portion 72c so as to overlap the bottom plate 14a of the chassis 14. In other words, the long-side second folded portion 73 and the long-side first folded portion 72 are circumscribed. The long-side first folded portion 72 forms an outer appearance of the long-side outer rim 21b, and the long-side second folded portion 73 is arranged adjacent to the outer edge of the rear surface of the bottom plate 14a of the chassis 14. The reinforcing plate 54 may be provided in the folded part of the long side second folded portion 73 (inside the long-side first folding portion 72).

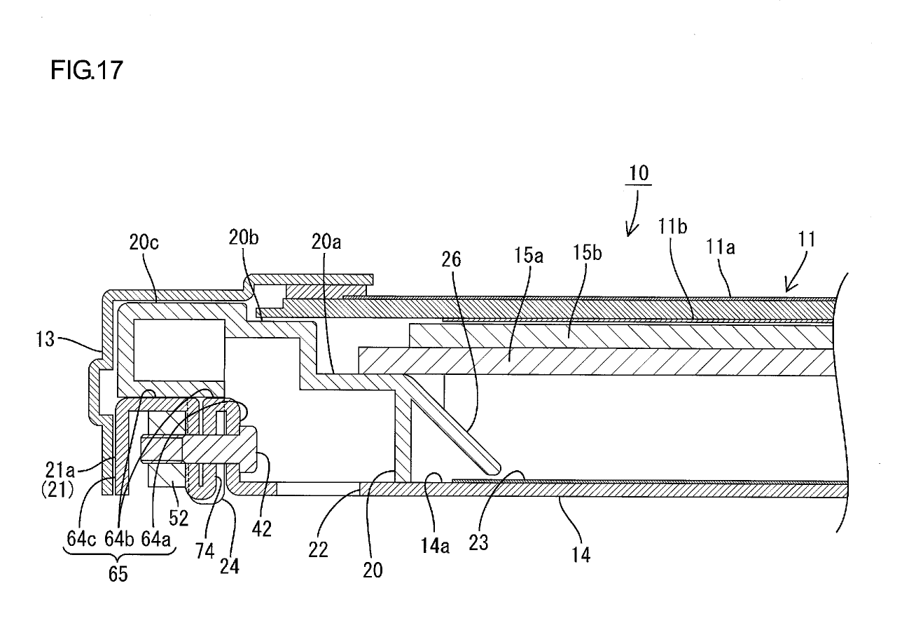

As illustrated in FIG. 17, the short-side first folded portion 65 and a short-side second folded portion 74 are formed at the short-side outer rim 21a. The short-side second folded portion 74 is formed by folding the third upper plate portion 64b of the short-side first folded portion 65 in a substantially U shape. Specifically, the short-side second folded portion 74 is formed in the folded part of the short-side first folded portion 65 so as to be closer to the third inner plate portion 64a. The short-side first folded portion 65 forms an outer appearance of the short-side outer rim 21a and the short-side second folded portion 74 is formed by folding a part of the third upper plate portion 64b of the short-side first folded portion 65 and provided in the short-side first folded portion 65 so as to overlap the third inner plate portion 64a. The reinforcing plate 52 may be provided in the folded part of the short-side first folded portion 65 (inside the short-side first folded portion 65) so as to be contacted to a surface of the short-side second folded portion 74 facing the third outer plate portion 64c with a plane surface contact. The reinforcing plate 52 may be fixed to the short-side second folded portion 74 by the screw 42 that is inserted from the third inner plate portion 64a.

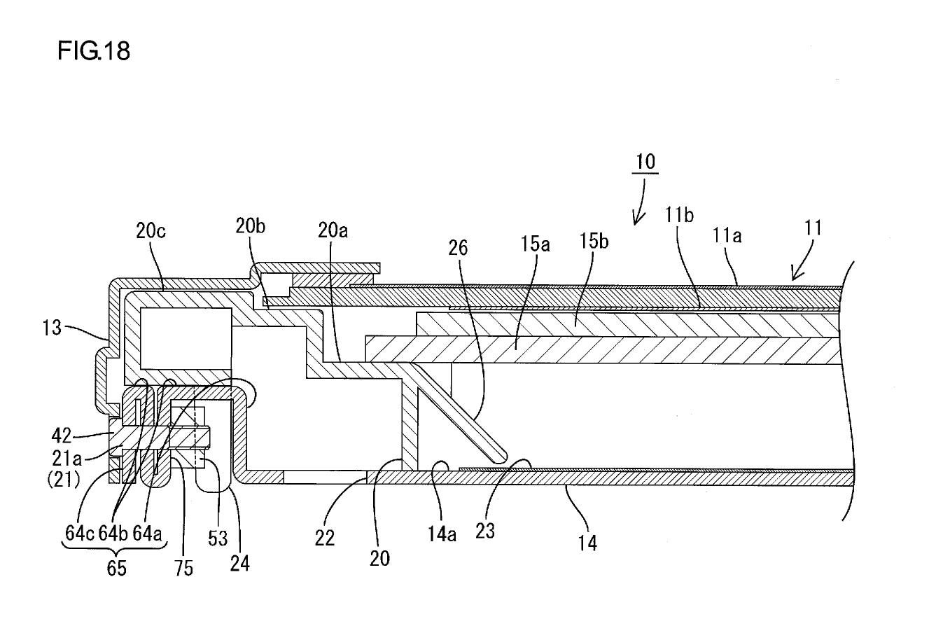

As illustrated in FIG. 18, the short-side first folded portion 65 and a short-side second folded portion 75 are formed at the short-side outer rim 21a. The short-side second folded portion 75 is formed by folding the third upper plate portion 64b of the short-side first folded portion 65 in a substantially U shape. Specifically, the short-side second folded portion 75 is formed in the folded part of the short-side first folded portion 65 so as to be closer to the third outer plate portion 64c. The short-side first folded portion 65 forms an outer appearance of the short-side outer rim 21a and the short-side second folded portion 75 is formed by a part of the third upper plate portion 64b of the short-side first folded portion 65 and provided in the short-side first folded portion 65 so as to overlap the third outer plate portion 64c. The reinforcing plate 53 may be provided in the folded part of the short-side first folded portion 65 (inside the short-side first folded portion 65) so as to be contacted to a surface of the short-side second folded portion 75 facing the third inner plate portion 64a with a plane surface contact. The reinforcing plate 53 may be fixed to the short-side second folded portion 75 by the screw 42 that is inserted from the third outer plate portion 64c.

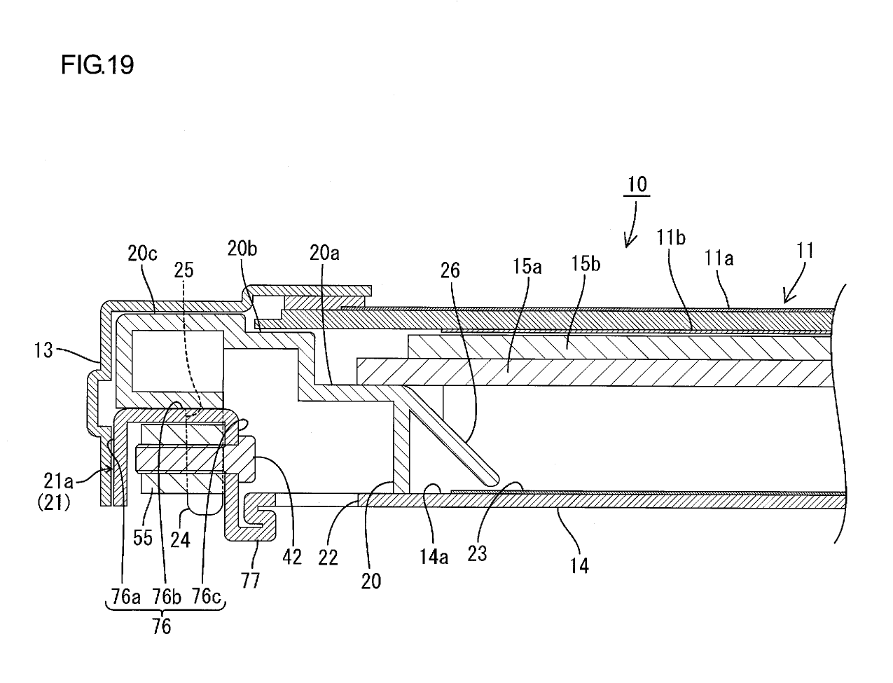

As illustrated in FIG. 19, a short-side first folded portion 76 and a short-side second folded portion 77 are formed at the short-side outer rim 21a. The short-side second folded portion 77 is formed by folding an end of the inner plate portion 76c of the short-side first folded portion in a substantially U shape and projected from the inner plate portion 76c so as to overlap the bottom plate 14a of the chassis 14. In other words, the short-side second folded portion 77 and the short-side first folded portion 66 are circumscribed. The short-side first folded portion 76 forms an outer appearance of the short-side outer rim 21a, and the short-side second folded portion 77 is arranged adjacent to the outer edge of the rear surface of the bottom plate 14a of the chassis 14. The reinforcing plate 55 may be attached to the inner plate portion 76c by the screw 42 so as to be provided in the folded part of the short-side first folded portion 76.

### Other Embodiments

The embodiments according to the present invention have been described. The present invention is not limited to the embodiments explained in the above description with reference to the drawings. The following embodiments may be included in the technical scope of the present invention, for example.

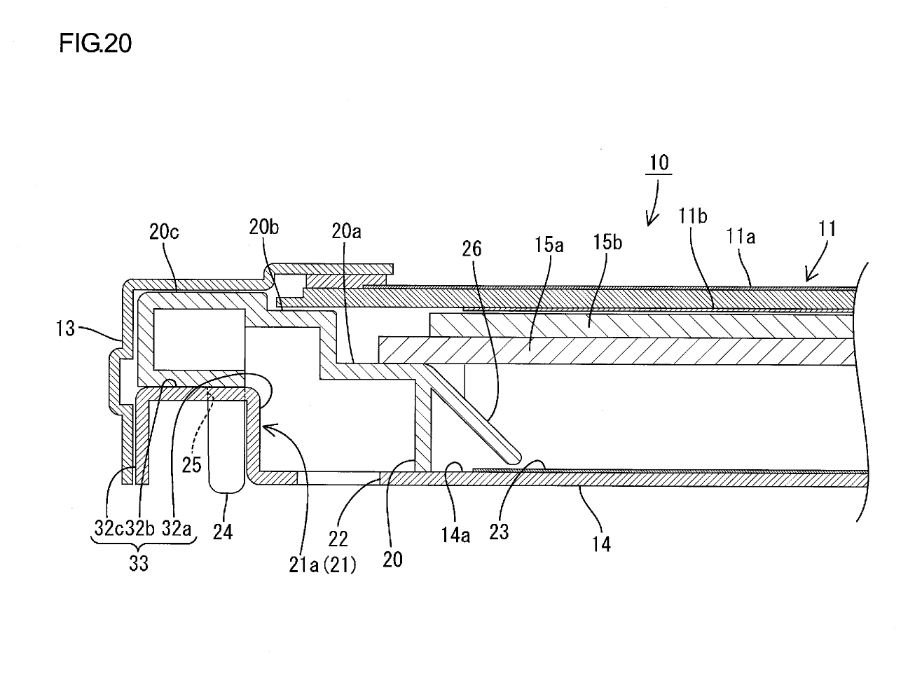

(1) In the above embodiments, the reinforcing plate 40 is attached to each of the short-side outer rim 21a and the long-side outer rim 21a of the chassis 14. However, the reinforcing plate 40 may be formed only on the long-side outer rim 21b according to the strength required for the chassis 14. In this case, the short-side outer rim 21a has a configuration comprising only the short-side folded portion 33, as illustrated in FIG. 20. Or the reinforcing plate 40 may be formed only on the short-side outer rim 21a.

(2) In the second embodiment, the short-side second folded portion 66 and the long-side second folded portion 62 are formed at the short-side outer rim 21a and the long-side outer rim 21b of the chassis 14, respectively. However, the long-side second folded portion 62 may be formed only at the long-side outer rim 21b according to the strength required for the chassis 14. Or the short-side second folded portion 66 may be formed only at the short-side outer rim 21a.

(3) In the above embodiments, the reinforcing plate 40 is attached to the outer rim 21 by the screw 42 that is a screw. However, the reinforcing plate 40 may be attached to the outer rim 21 by an organic/inorganic adhesive or a stopper pin having a stopper at its distal end.

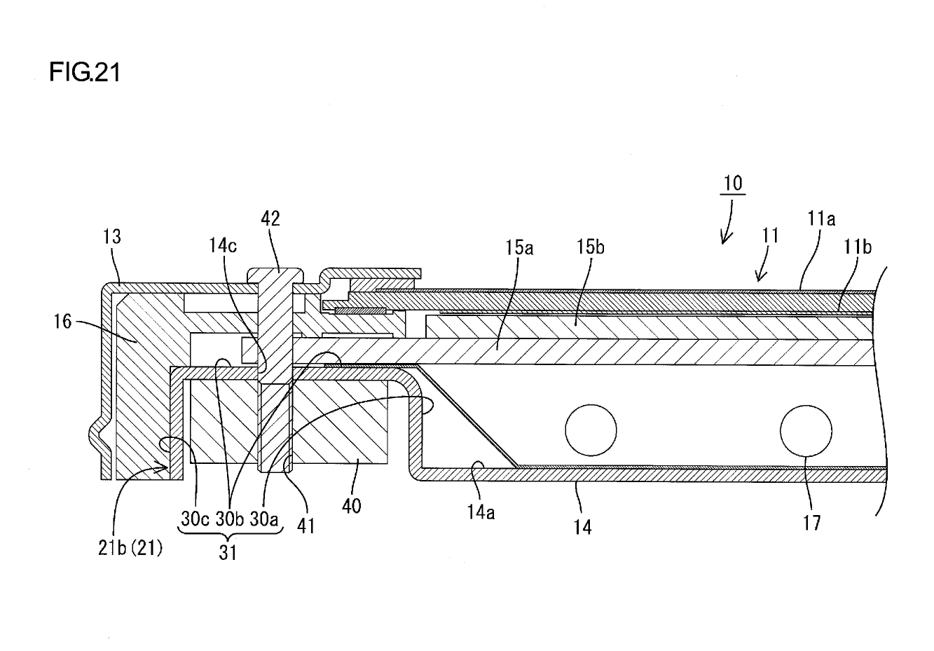

(4) In the above embodiments, the outer rims 21, the reinforcing plate 40 and the bezel 13 are collectively fixed together by one screw 42. However, for example as illustrated in FIG. 21, the outer rims 21, the reinforcing plate 40 and the diffuser plate 15a and/or the optical sheets 15b may be collectively fixed together.

(5) In the above embodiments, the cold cathode tubes 17 are used as light sources. However, other types of light sources including hot cathode tubes can be used.

1. A lighting device comprising:
a plurality of light sources; and
a chassis configured to accommodate the light sources, wherein:
the chassis includes a flat bottom plate and an outer rim that is formed at an edge of the bottom plate and has a folding configuration; and
a core member is provided in a folded part of the folding configuration at the outer rim so as to extend in a longitudinal direction of the outer rim.

2. The lighting device according to claim 1, wherein:
the folding configuration has a substantially U shape; and
the core member is provided inside the substantially U shape of the folding configuration.

3. The lighting device according to claim 1, wherein:
the core member is attached to the outer rim by a fixing member; and
the fixing member is passed through the core member and a plate member forming the outer rim such that the core member and the plate member are fixed together.

4. The lighting device according to claim 1, wherein the fixing member is a screw that is inserted from outside of the folded part of the outer rim.

5. The lighting device according to claim 1, wherein the core member is attached to the outer rim extending in a long-side direction of the chassis.

6. The lighting device according to claim 1, wherein the core member is attached to the outer rim extending in a short-side direction of the chassis.

7. The lighting device according to claim 3, further comprising an optical member configured to change light emitting characteristics of light emitted from the light sources, the optical member being provided at a light output side with respect to the light sources, wherein:
the optical member is arranged such that an edge thereof overlaps the outer rim; and
the fixing member fixes the edge of the optical member and the core member to the outer rim.

8. The lighting device according to claim 1, wherein the folding configuration of the outer rim includes a first folded portion that is formed by folding a plate member and a second folded portion that is formed by folding the plate portion that forms the first folded portion.

9. The lighting device according to claim 8, wherein the first folded portion is folded in a substantially U shape and the second folded portion is formed inside the substantially U shape of the first folded portion.

10. The lighting device according to claim 1, wherein a distance between the light sources and the bottom plate is 2.5 mm or less.

11. The lighting device according to claim 1, wherein a height of the outer rim in a vertical direction with respect to a plate surface of the bottom plate is 10.0 mm or less.

12. A display device comprising:
the lighting device according to claim 1; and
a display panel configured to provide display using light from the lighting device.

13. The display device according to claim 12, wherein:
the lighting device and the display panel are integrally held by a bezel that is provided at an edge of each of the lighting device and the display panel;
the core member is attached to the outer rim of the chassis provided in the lighting device by a fixing member; and
the fixing member fixes the bezel and the core member to the outer rim.

14. The display device according to claim 12, wherein the display panel is a liquid crystal display using liquid crystal.

15. A television receiver comprising the display device according to claim.
